(19) United States
(12) Patent Application Publication
(10) Pub. No.: US 2004/0165586 A1
(43) Pub. Date: Aug. 26, 2004

(54) PID filters based network routing

(76) Inventors: Christopher Jensen Read, San Diego, CA (US); Robert L. Hardacker, Escondido, CA (US)

Correspondence Address: MILLER PATENT SERVICES, 2500 DOCKERY LANE, RALEIGH, NC, 27606, US

(21) Appl. No.: 10/373,479

(22) Filed: Feb. 24, 2003

(51) Int. Cl. H04L 12/56

(52) U.S. Cl. 370/389; 370/392

(57) ABSTRACT

A television Set-top box based content server consistent with certain embodiments of the present invention has a receiver that receives a transport stream containing data representing content in packets, wherein the packets are identified by packet identifiers (PIDs). A PID filter selects packets having a specified PID. A mapper maps packets having the specified PID to an Internet Protocol (IP) address. The mapper uses the PID as an index to a translation table and retrieves the IP address from the translation table. A packet converter converts the packets identified by the specified PID to an IP packet having the IP address. A router, such as a wireless ultra-wideband router, routes the IP packet to a recipient according to the IP address.

### FIELD OF THE INVENTION

This invention relates generally to the field of multimedia networking. More particularly, certain embodiments consistent with this invention relate to translation of a program identifier (PID) to an Internet Protocol (IP) address in order to distribute entertainment content or other content within a multimedia network environment (e.g., a home entertainment network).

### BACKGROUND OF THE INVENTION

As the cost of computing power and networking equipment declines, multimedia devices such as home entertainment equipment is gradually becoming networked along with other network enabled equipment within a consumer's household. This opens up possibilities for enhanced distribution of entertainment content throughout a household.

The inter-operation of such home entertainment equipment can present numerous challenges. When multiple client playback devices in such a system receive content from multiple sources (e.g., a DVD player), it is generally a relatively simple matter to route the appropriate information to the appropriate client device. However, when one source such as a cable television system, provides different content to multiple client devices, the problem becomes substantially more complex. The present invention, thus, addresses the challenge of distribution of content from a cable or satellite television system transport stream (or any other transport stream containing multiplexed content) within a multimedia network environment.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of a portion of a home network consistent with certain embodiments of the present invention.

FIG. 2 is a flow chart describing a PID to IP conversion process consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

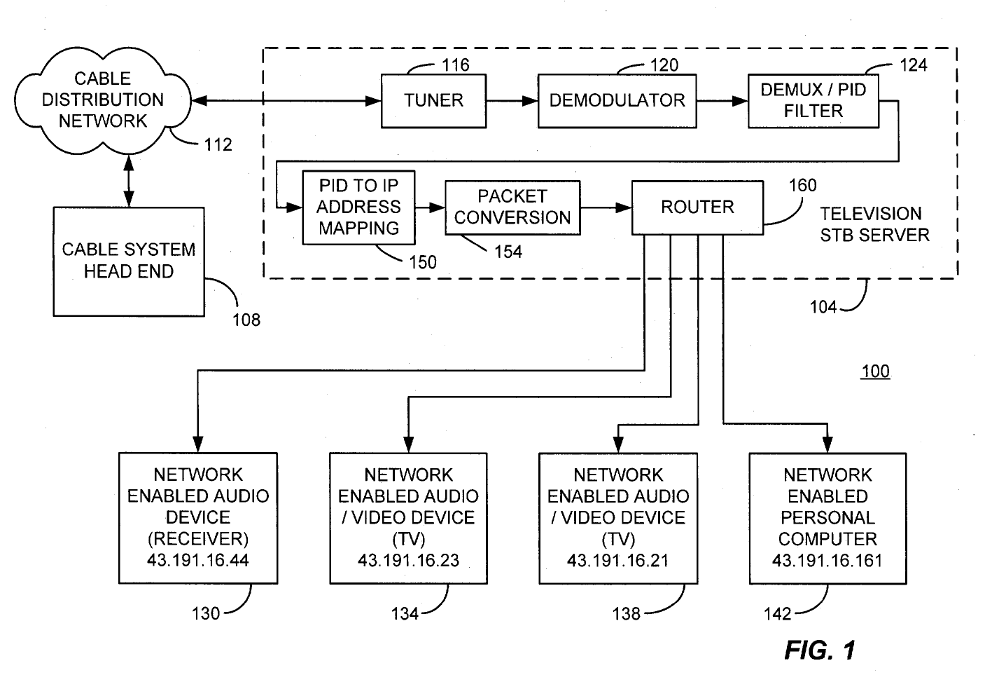

Turning now to FIG. 1, an exemplary television Set-top box (STB) centric home multimedia network 100 is depicted. In this exemplary embodiment, a television STB, such as that used to convert from a digital cable television system or a satellite television system or a terrestrial broadcast system to a television signal, is used as a server 104 for a home network. However, in other embodiments, other sources of a multiplexed stream of content could be used, including but not limited to, the above sources, an MPEG 2 (Moving Pictures Expert Group) compliant Transport Stream (TS), an ATSC (Advanced Television Systems Committee) compliant data stream, or a stream of content formed by merging content from a number of individual sources (e.g., for efficiency in distribution within a system). Moreover, the present invention should not be limited to a content server forming a part of a television STB. While the various components to be described are shown as part of the STB server 104, other variations will occur to those skilled in the art without departing from the present invention. In this example, STB server 104 is used to receive streams of data from a cable television system depicted by a cable system head end 108 that sends content to the STB 104 via a cable distribution network 112.

The STB 104 depicted herein is shown in simplified form to facilitate discussion of the relevant portions of the present invention, but those skilled in the art will appreciate that other functional blocks (e.g., those that support conditional access, etc.) have been omitted for simplicity. The content is received by the STB server 104 at tuner 116 which tunes to the frequency of the desired channel carrying a desired transport stream (TS) of content. The signal from the tuner is demodulated at demodulator 120 to supply a baseband multiplexed transport stream of data packets that contains multiple elementary streams of data associated with multiple programs within the transport stream. This transport stream is then provided to a demultiplexer (demux) 124. Demultiplexer 124 functions as a filter which selects packets in the transport stream based upon a desired program identifier (PID) that identifies sub-streams associated with a particular selection of content (e.g., a television program). Normally, once these packets are selected the STB would convert these packets to a format useful to a television receiver, for example, by decompression and conversion to analog and possibly modulation of the signal to a specified channel (e.g., channel 3 or 4). However, in the present embodiment, STB 104 serves as a server to network 100 and provides content to any number of network enabled client playback devices that are coupled to the network.

In this example, client playback devices 130, 134, 138 and 142 are connected to the network either by, for example, a wired ethernet connection or by a wireless connection such as a bluetooth connection, an IEEE 802.11 (a) or (b) connection, ultra-wideband (UWB) connection (for example as is being standardized by the ulltra-wideband working group—UWBWG), or other suitable connection that permits the devices to be addressed selectively according to an assigned Internet Protocol (IP) address. In other embodiments, other types of networking could equally well be applied such as, for example, HPNA (Home Phoneline Networking Alliance) compliant networks, PLC (PowerLine Communications) networks, coaxial optical networks or any other suitable communication network. In a UWB wireless radio communication network, even multiple high definition television signals can be multiplexed over a home network system. In this example, device 130 is shown as a network enabled audio device such as a stereo receiver (i.e., no video capability). Device 130 is shown to have an IP address of 43.191.16.44. Devices 134 and 138 are shown to be network enabled television-like devices that receive audio and video information via IP addresses 43.191.16.23 and 43.191.16.21 respectively. Device 142 is shown to be a network enabled personal computer with IP address 43.191.16.161 and can be used to receive audio, video and/or data via the IP address.

When a PID filtered stream of data having a particular PID emerges from demultiplexer 124, it is passed to a PID to IP address mapper 150. This functional block receives packets formatted, for example, as MPEG 2 (Moving Pictures Expert Group) packets, that contain audio, video and/or user data information, with each packet having a PID that identifies the program with which the data are associated. In order to direct this data to a desired-location, address mapper 150 maps the PID value to an IP address of the device to which the data should be directed. The MPEG 2 format packet is then reformatted as an IP packet with the IP address or addresses associated with the PID value at packet converter 154. At the output of packet converter 154 is a stream of IP packets that are sent to a network router 160 that then routes the packets to their appropriate destination in any suitable manner.

While router 160 is shown as an internal component of the STB server 104, in other embodiments, STB server 104 could simply supply output from packet converter 154 as an output using, for example, ethernet in order to downlink to an outboard router to accomplish a similar function without departing from the present invention. It is also noted that, although a client-server structure is described, the certain embodiments consistent with the present invention can also be realized in a peer-to-peer network environment without departing from the invention.

Thus, a television Set-top box based content server consistent with certain embodiments of the present invention has a receiver that receives a transport stream containing data representing content in packets, wherein the packets are identified by packet identifiers. A PID filter selects packets having a specified PID. A mapper maps packets having the specified PID to an Internet Protocol address. The mapper uses the PID as an index to a translation table and retrieves the IP address from the translation table. A packet converter converts the packets identified by the specified PID to an IP packet having the IP address. A router routs the IP packet to a recipient according to the IP address.

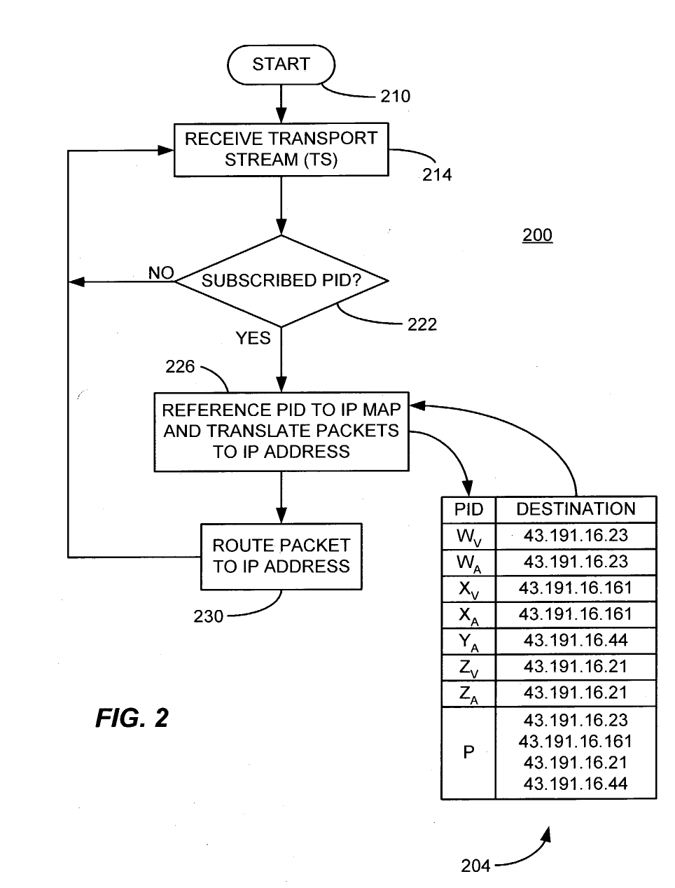

In one embodiment consistent with the present invention, a customer may subscribe to a particular program or other element of content identified by one or more PIDs for viewing or listening on a specified device. For example, a program or movie may be subscribed to by a customer for playback on an upstairs television set (e.g., device 138) while other programming might be subscribed to for a downstairs television set (e.g., device 134). Paid audio programming might be subscribed to for playback on audio device 130, while other content might be subscribed to for use on the personal computer 142. Other programming may be directed by subscription or other arrangement to any or all of the four exemplary client devices 130, 134, 138 and 142 as desired. This programming is identified by the cable system using PIDs. Thus, a table can be constructed such as that shown in FIG. 2 as table 204 to be used in a translation process 200 depicted in FIG. 2.

Table 204 relates PID values to IP addresses as shown. In this example, eight PID values are shown as W_{V}, W_{A}, X_{V}, X_{A}, Y_{A}, Z_{V}, Z_{A} and P where the subscript V and A represent video and audio content respectively. Thus, according to this table, content with PID values W_{V} and W_{A} are directed to television device 134, content with PID values X_{V} and X_{A} are directed to computer device 142, content with PID value Y_{A} is directed to audio receiver 130, content with PID values Z_{V} and Z_{A} are directed to television device 138, and packets with PID value P is directed to all four devices. This mapping process can be implemented, for example in an integrated circuit chip in the server 104 designed to receive the transport stream and carry out the filtering, mapping and routing processes described. Such an integrated circuit may be implemented alone or together with the PID filtering, for example. Other realizations are also possible without departing from the invention. In other embodiments, a programmed processor may be used to carry out the PID to IP address mapping and other functions described herein without departing from the invention.

The routing mechanism described above need not route each packet individually. The MPEG packets destined for a particular destination can be accumulated to fill a prescribed packet size at packet converter 154 to improve network efficiency. That is, there need not be a one-to-one PID packet to IP packet relationship in the packet conversion process. Moreover, the packets that are sent to more than one destination can be queued up for each of the destinations and then sent. Alternatively, IP broadcast or IP multicast techniques can be used to send packets destined for more than one client device. Other variations will occur to those skilled in the art upon consideration of the present teaching.

FIG. 2 depicts an exemplary process 200 used to carry out the PID filtering, PID to IP address mapping and packet translation processes according to certain embodiments of the present invention starting at 210. At 214, the input transport stream is received at demultiplexer 124 and at 222, demultiplexer 124 selects desired packets from the transport stream from a list of desired packets. This list can be produced by virtue of a subscription process, by programming or by selection of a channel on the client device, for example. In this case, for example, if all of the content is being received simultaneously, the PID filtering operation selects all packets with PID values of W_{V}, W_{A}, X_{V}, X_{A}, Y_{A}, Z_{V}, Z_{A} and P, and discards all other packets with any other PID values (except possibly designated values used for system purposes). Thus, if a packet contains any of the desired PID values at 222 (e.g., by virtue of a subscription), the packet is passed to 226, otherwise it is discarded and control returns to 214. In this manner, only packets with desired PID values are selected from the transport stream.

At 226, PID to IP table 204 is referenced, using the PID value as an index to table 204, in order to translate PIDs to IP addresses as described above. For example, PID value W_{V} would be destined for IP address 43.191.16.23 (television device 134). The packet's data is then reformatted or otherwise placed in an IP formatted packet (if required) and the packet is routed to the desired IP address by the router 160 at 230. The process then returns to 214 in anticipation of receipt of the next packet. Those skilled in the art will understand that many variations of this process are possible without departing from the present invention.

Thus, in accordance with certain embodiments consistent with the present invention, a method of processing data packets, involves receiving a transport stream containing a packet of data identified by a program identifier (PID); mapping the PID to an Internet Protocol (IP) address; and converting the packet to an IP packet containing the data and having the IP address. The process may further involve routing the IP packet to a networked device having the IP address. The routing may be carried out in a wireless router such as one that transports data using an ultra-wideband channel.

Those skilled in the art will recognize that certain embodiments of the present invention can be based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements,(magnetic storage elements, magneto-optical storage elements, flash memory, core memory and/or other equivalent storage technologies without departing from the present invention. Such alternative storage devices should be considered equivalents.

The present invention, as described in certain embodiments herein, can be implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of processing data packets, comprising:
receiving a transport stream containing a packet of data identified by a program identifier (PID);
mapping the PID to an Internet Protocol (IP) address; and
converting the packet to an IP packet containing the data and having the IP address.

2. The method according to claim 1, further comprising routing the IP packet to a networked device having the IP address.

3. The method according to claim 2, wherein the routing is carried out in a wireless router.

4. The method according to claim 3, wherein the wireless router transports data using an ultra-wideband channel.

5. The method according to claim 1, wherein the mapping comprises using the PID as an index to a translation table and retrieving the IP address from the translation table.

6. The method according to claim 1, further comprising retrieving the packet of data identified by the PID from the transport stream by PID filtering the transport stream.

7. The method according to claim 1, wherein the transport stream comprises one of a cable television transport stream, a terrestrial broadcast transport stream and a satellite television transport stream.

8. The method according to claim 1, wherein the packet contains at least one of video and audio content.

9. The method according to claim 1, carried out in a television Set-top box.

10. A computer readable storage medium storing instructions which, when executed on a programmed processor, carry out a method of processing data packets according to claim 1.

11. A content server, comprising:
a receiver that receives a transport stream containing data representing content in packets, wherein the packets are identified by packet identifiers (PIDs);
a PID filter that selects packets having a specified PID;
a mapper that maps packets having the specified PID to an Internet Protocol (IP) address; and
a packet converter that converts the packets identified by the specified PID to an IP packet having the IP address.

12. The content server according to claim 11, further comprising a router that routs the IP packet to a recipient according to the IP address.

13. The content server according to claim 11, wherein the router comprises a wireless router.

14. The content server according to claim 13, wherein the wireless router transports data using an ultra-wideband channel.

15. The content server according to claim 13, wherein the router comprises an ethernet router.

16. The content server according to claim 11, wherein the mapper uses the PID as an index to a translation table and retrieves the IP address from the translation table.

17. The content server according to claim 11, wherein the transport stream comprises one of a cable television transport stream and a satellite television transport stream.

18. The content server according to claim 11, wherein the packet contains at least one of video and audio content.

19. The content server according to claim 11, embodied in a television Set-top box.

20. A television Set-top box based content server, comprising:
a receiver that receives a transport stream containing data representing content in packets, wherein the packets are identified by packet identifiers (PIDs);
a PID filter that selects packets having a specified PID, wherein the packet contains at least one of video and audio content;
a mapper that maps packets having the specified PID to an Internet Protocol (IP) address, wherein the mapper uses the PID as an index to a translation table and retrieves the IP address from the translation table;
a packet converter that converts the packets identified by the specified PID to an IP packet having the IP address; and
a router that routes the IP packet to a recipient according to the IP address.

21. The content server according to claim 20, wherein the transport stream comprises one of a cable television transport stream and a satellite television transport stream.

22. The content server according to claim 20, wherein the router comprises a wireless router.

23. The content server according to claim 20, wherein the router comprises an ethernet router.

24. The content server according to claim 20, wherein the wireless router transports data using an ultra-wideband channel.
